(19) United States
(12) Patent Application Publication
(10) Pub. No.: US 2009/0052275 A1
(43) Pub. Date: Feb. 26, 2009

(54) ARRANGEMENT FOR MIXING STEAM INTO A FLOW OF CELLULOSE PULP

(76) Inventor: Ulf Jansson, Karlstad (SE)

Correspondence Address: JAMES EARL LOWE, JR., 15417 W NATIONAL AVE # 300, NEW BERLIN, WI, 53151, US

(21) Appl. No.: 12/088,562

(22) PCT Filed: Sep. 26, 2006
(86) PCT No.: PCT/SE06/50350

§ 371 Date: Jul. 7, 2008

(30) Foreign Application Priority Data
Sep. 29, 2005 (SE) 0502140-7

(51) Int. Cl. B01F 5/04

(52) U.S. Cl. 366/162.4

(57) ABSTRACT

The invention concerns an arrangement to counteract problems associated with mixing in steam into a pipe that is transferring a flow of pulp of medium consistency. The arrangement comprises a chamber (101) with a cross-sectional area (A3), and a pre-determined length (x). The chamber (101) is in connection, upstream to the flow of pulp, with a first throttle section (107) that has a cross-sectional area (A1). The addition of steam through supply means (105) takes place in the first throttle section (107). The chamber (101) is in connection, downstream to the flow of pulp, with a second throttle section (122) that has a cross-sectional area (A2). The cross-sectional area (A3) of the chamber is greater than the cross-sectional area (A1) of the first throttle section and the cross-sectional area (A2) of the second throttle section. The decrease in area between the cross-sectional area (A3) of the chamber and the cross-sectional area (A2) of the second throttle section takes place instantaneously, in one single step.

### TECHNICAL AREA

The present invention concerns an arrangement for counteracting problems in association with the mixing of steam into a pipe that is transporting a flow of cellulose pulp of medium consistency, as described by the introduction to claim 1.

### THE PRIOR ART

Cellulose pulp of several consistencies is handled during the production of chemical cellulose pulp, from low consistency 1-5%, through medium consistency 8-14%, to high consistency >28-30%. The handling of low consistency pulp normally does not involve any major problems since the pulp suspension has properties that are more or less those of a fluid. It is, however, desired in many cases to reduce to a minimum the volumes of circulating fluids in order to minimise the requirements for pumps, volumes of waste released, and the requirement for chemicals, etc.

Cellulose pulp of medium consistency is more difficult to handle since it involves the formation of blockages in the flow of pulp in the pipes, and active fluidisation is required in certain cases during at least one of pumping and mixing, which fluidisation may take place through powerful mechanical stirring. A flow of pulp of medium consistency has the character of a flow of a blockage of a well-connected network of fibres, and during the addition of steam to such a flow of a blockage it is extremely important that the steam has a high relative pressure and that it is injected in thin streams, in order to obtain an even distribution throughout the complete flow of the blockage. It may on occasions be desirable, for various reasons, to raise the temperature of the pulp of medium consistency, and this is preferably carried out using hot steam that is injected into the pulp. The heating of cellulose pulp of medium consistency by direct steam may be, however, difficult to carry out for several reasons. One reason is the difficulty of finely distributing the steam while at the same time maintaining the pulp suspension in such motion that condensation takes place in a controlled and continuous manner, something that requires, namely, that the steam is finely distributed evenly throughout the fluid or suspension. This is particularly difficult when a large volume of steam is to be added. It may occur, furthermore, when adding steam, that the volume of the steam bubbles may become so large that the heat convection between the steam and the fluid becomes insufficient for the desired continuous condensation. This gives rise to the occurrence of intermittent, powerful, steam implosions that cause bangs and blows. These may be so powerful that mechanical damage arises, and this process is more severe when more steam is added.

The prior art solutions for reducing the problems of steam implosions in pipes are often clever designs for the steam nozzle in order to achieve a good initial distribution of steam. The steam in U.S. Pat. No. 4,659,521, for example, is added centrally in the flow of fluid against a spreader plate that is to distribute the steam as a thin layer in the shape of a fan jet. U.S. Pat. No. 3,984,504 shows another type of steam distributor that is to distribute the steam in the form of finely distributed streams.

A second method has been to add at least one of more moist steam and more moist oxygen gas in association with the addition of steam, and this has been shown to have a beneficial effect and reduce the steam implosions. These measures are often taken in heating systems, where these have been constructed from thick-walled cast iron, often permanently cast into concrete foundations with the aim of ensuring that they can withstand a certain occurrence of steam implosions.

SE 512 192/U.S. Pat. No. 6,659,635 shows an arrangement for the mixing in of steam into a pulp consistency, where the aim of the arrangement is to give improved mixing of the steam throughout the pulp. This is achieved by having an increase in area after the addition of steam of at least 50%, which ensures that the pulp is exposed to powerful turbulence and retardation, which in turn means that there is sufficient time for effective mixing and that the steam is given additional time for condensation inside the flow of pulp. Furthermore, the sudden increase in area reduces the probability that injected steam reaches the wall of a subsequent section of channel, something that otherwise would result in rapid cooling and steam implosions as a result of the steam reaching the inner surface of the channel wall.

The problem with steam implosions, however, is very complex, and it has proved to be extremely difficult to solve these problems by changing the conditions under which the steam is added, as described above, or by the use of heavy and powerful designs. The addition of steam can often take place without major problems at a certain specified flow of cellulose pulp and at a specified degree of heating, with a certain type of steam supply arrangement, but problems may arise when the flow of cellulose pulp only constitutes a small part of the nominal flow.

### THE AIM OF THE INVENTION

The principal aim of the invention is to achieve an arrangement that fully or partially solves the problems and disadvantages of steam implosions described above.

A second aim is that the arrangement is to reduce the occurrence of steam implosions in a pipe that transfers a flow of pulp of medium consistency, where the steam implosions have arisen in association with the heating of the flow of pulp by direct injection of the steam into the flow of pulp in the pipe.

A third aim is to reduce the bangs and blows to which the steam implosions described above give rise.

A fourth aim of the invention is to make it possible to avoid the arrangement for the addition of steam and the associated pipes being shaken to pieces and causing interruptions in production, and that it will not be necessary to have heavy and over-dimensioned foundations or pipes that resist these powerful blows.

A fifth aim of the invention is to make it possible to increase the degree of heating up to, or even above, the level at which the steam implosions otherwise start to arise. Furthermore, the superheating of the steam may also be increased.

The above aims of the invention are achieved with an arrangement that counteracts the problems that arise in association with the mixing in of steam in accordance with the characterising part of patent claim 1.

### DESCRIPTION OF DRAWINGS

FIG. 1 shows a first preferred embodiment of the arrangement according to the invention.

FIG. 2 shows a second preferred embodiment of the arrangement according to the invention.

FIG. 3 shows a third preferred embodiment of the arrangement according to the invention.

FIG. 4 shows a fourth preferred embodiment of the arrangement according to the invention.

### DETAILED DESCRIPTION OF THE INVENTION

The concepts “cellulose pulp of medium consistency” and “flow of pulp” will be used in the detailed description of the invention given below. The term “cellulose pulp of medium consistency” is here used to denote a suspension with a concentration of cellulose pulp of 8-16%, preferably 8-11%, and the term “flow of pulp” is here used to denote a flow of the said cellulose pulp in a pipe.

The expression “steam implosion” will, furthermore, be applied. The term “steam implosion” is here used to denote an effect that may arise in association with the addition of steam to a flow of pulp with the aim of increasing the temperature of the cellulose pulp. One of the difficulties during the addition of steam to the flow of pulp is that of finely distributing the steam while at the same time maintaining the pulp is such motion that a controlled and continuous condensation takes place, which requires, namely, that the steam is evenly distributed throughout the flow of pulp. This is particularly difficult when a large amount of steam is added. It may occur, furthermore, when adding steam, that the volumes of the steam bubbles become so large that the heat convection between the steam and the fluid becomes insufficient for the desired continuous condensation. This gives rise to the occurrence of intermittent, powerful, steam implosions that cause bangs and blows of high amplitude, which bangs and blows risk shaking apart pipes, valves and other components of the construction that are part of the pipe system.

Finally, the concept “cross-sectional area (A1, A2 and A3)” will be used The term “cross-sectional area” is here used to denote the area at which the flow of pulp of cellulose pulp flows. This is thus an area of a flow cross-section.

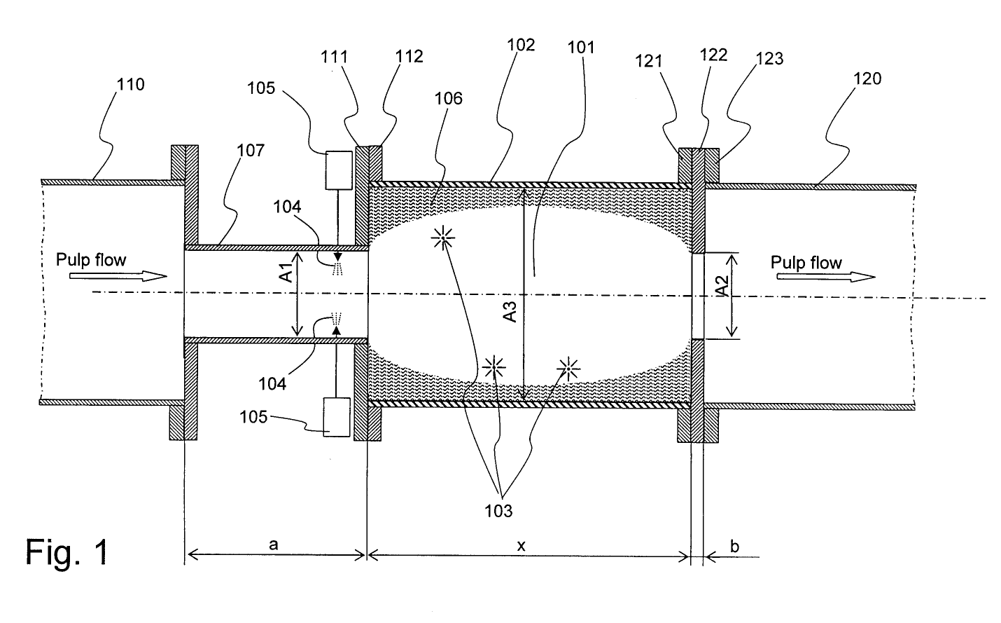

FIG. 1 shows a first preferred embodiment of an arrangement to counteract problems in association with the mixing in of steam to a pipe that transfers a flow of cellulose pulp of medium consistency. The arrangement counteracts the occurrence of steam implosions, and it suppresses the bangs and blows to which the steam implosions give rise, as will be described in more detail below.

The arrangement comprises a chamber 101 with a cross-sectional area (A3), and it has a pre-determined length (x). The chamber 101 is limited in the radial direction by a cover 102, which is preferably constituted by a circularly cylindrical element with the shape of a pipe.

The chamber 101 is in connection, upstream to the flow of pulp, with a first throttle section 107, through the cover 102 connecting to the first throttle section 107 through flanges 111/112. The first throttle section has a cross-sectional area (A1) and a pre-determined length (a). The addition of steam 104 through supply means 105 takes place in this first throttle section. The supply means are preferably a steam mixer of the type shown in SE 512 192/U.S. Pat. No. 6,659,635.

The first throttle section 107 is in turn in contact, upstream, with a first pipe 110, which in this embodiment has a larger cross-section of flow. It is preferable that the channel 110 is adapted for a certain flow, and it may have a diameter of 600-800 mm, in a plant that passes 800-1500 tonnes of pulp per day. The first throttle section 107 establishes a reduced cross-sectional area of flow (A1) in which the flow of pulp accelerates during the addition of steam in the throttle section, which acceleration is beneficial for effective mixing in of the steam in the flow of pulp.

The chamber 101 is in connection, downstream to the flow of pulp, with a second throttle section 122, through the cover 102 connecting to the second throttle section 122 through flanges 121/123. This second throttle section 107 has a cross-sectional area (A2) and a pre-determined length (b). The second throttle 122 section is in turn in contact with a second pipe 120. The second pipe 120 has in this embodiment the same, or essentially the same, diameter as the first pipe 110.

The cross-sectional area (A3) of the chamber is greater than the cross-sectional area (A1) of the first throttle section and the cross-sectional area (A2) of the second throttle section. In one most preferred embodiment, the cross-sectional area (A3) of the chamber is at least 50% greater than the cross-sectional area (A1) of the first throttle section and the cross-sectional area (A2) of the second throttle section.

The increase in area between the cross-sectional area (A1) of the first throttle section and the cross-sectional area (A3) of the chamber takes place in FIG. 1 instantaneously, in one single step. In an alternative embodiment (not shown in the drawings), the increase in area between the cross-sectional area (A1) of the first throttle section and the cross-sectional area (A3) of the chamber takes place within a stretch that is less than the diameter, or another equivalent measure of cross-sectional area, of the first throttle section 107. Thus the increase in area can also take place in a gradual manner or linearly along a short stretch, along the direction of flow, of 20-40% of the diameter of the first throttle section.

The decrease in area between the cross-sectional area (A3) of the chamber and the cross-sectional area (A2) of the second throttle section takes place in FIG. 1 instantaneously, in one single step. In an alternative embodiment (not shown in the drawings), the decrease in area between the cross-sectional area A3 of the chamber and the cross-sectional area A2 of the second throttle section can take place within a stretch that is considerably less than the diameter, or another equivalent measure of cross-sectional area, of the second throttle section 122. It is, however, important that it is possible for the wall that is formed by the upstream side of the second throttle section, against the flow of the suspension of pulp, to retain a volume of fibres 106 out against the wall of the chamber, without this volume of fibres 106 being caught up in the flow with a rate of turnover that is too high. It is most preferable that an essentially stationary volume of fibres 106 is retained by the wall that is formed.

It is an advantage if the length (x) of the chamber is at least twice, even as much as 10 times, the diameter of the chamber, or other equivalent measure of cross-sectional area.

The cross-sectional area of the first pipe 110 is greater than the cross-sectional area A1 of the first throttle section, it is preferable that the cross-sectional area of the first pipe is greater than 50% greater than the cross-sectional area (A1) of the first throttle section.

The cross-sectional area of the second pipe 120 may be, as it is in FIG. 1, greater than the cross-sectional area A2 of the second throttle section, but it may also, in an alternative embodiment (not shown in the drawings), be of the same dimension as A2. It is possible to envisage in the latter case that the chamber 101 opens directly out into the second pipe 120 (which has a smaller cross-sectional area than the chamber), and that the second pipe 120 in this case functions as a second throttle section 122.

Since the cross-sectional area A3 of the chamber is greater than the cross-sectional areas A1 and A2 of the first and second throttle sections, the suspension of pulp will be retained in those areas of the chamber that lie radially outside of A1 and A2 (when seen from a central line through the chamber), and it will be retained against the side of the second throttle section that lies upstream. A volume of fibres 106 of stationary cellulose pulp thus will successively be built up along the inner surface of the chamber. The pulp in the centre of the chamber, in contrast, will continue with a high speed through the chamber and over into the second pipe 120, where it returns to the speed of flow that it had in the first pipe 110 (under the assumption that these pipes, 110 and 120, have the same diameter), when the pulp of medium consistency passes through the first pipe.

The volume of fibres 106 that is retained against the upstream side of the second throttle section will act in two ways: it will insulate against steam reaching the colder parts of the wall of the chamber 102, and it will allow the formation of a sound-absorbing bed that absorbs bangs from any steam implosions that take place spontaneously in the flow of pulp. The steam that is added is thus given an extended time for condensation in the flow of pulp before the steam and pulp can reach colder parts of the wall in the flow pipes. The volume of fibres 106 that is formed in the retardation zone along the walls of the chamber 101 ensures that the steam that is added before the inlet to the chamber 101 does not have sufficient time to cool by contact with the cold cover 102 in the chamber, and this means that the occurrence of steam implosions is highly reduced.

The volume of fibres 106, furthermore, reduces bangs and vibrations that arise as a result of the steam implosions that do, despite everything, still occur.

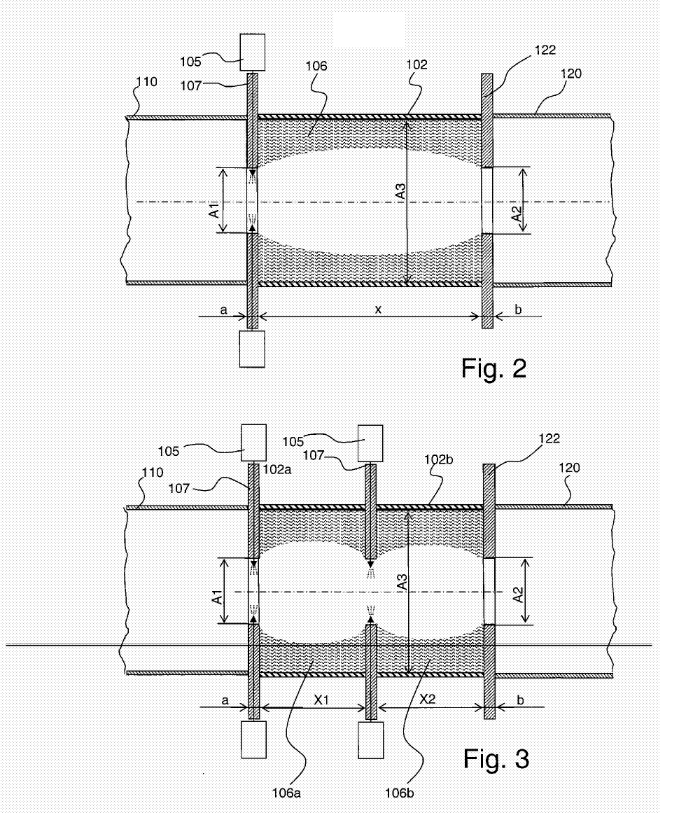

FIG. 2 shows a second preferred embodiment of the invention that can be applied on the first embodiment. The first throttle section 107 in this case is constituted by a single flange plate with at least one radial hole, through which steam is added. Two opposing holes for the addition of steam are shown in the drawing, but more may be arranged evenly distributed around the perimeter of the flange plate. This design is very simple, since the necessary components consist solely of plates 107, 122 and a cover 102, which is held fixed to the pipes 110/120 between flange connections.

FIG. 3 shows a third preferred embodiment of the invention that can be applied on the embodiments described above. The first throttle section in this case is constituted by several, in this case two, flange plates 107 through which steam is added. A more even addition of the steam is achieved in this embodiment since not all steam is added at a single location. Fibre volumes 106a, 106b are built up in this case in the same way as previously. It is obvious that more than two flange plates with locations at which steam is added may be arranged before and in the chamber, one after the other with a pre-determined distance between them.

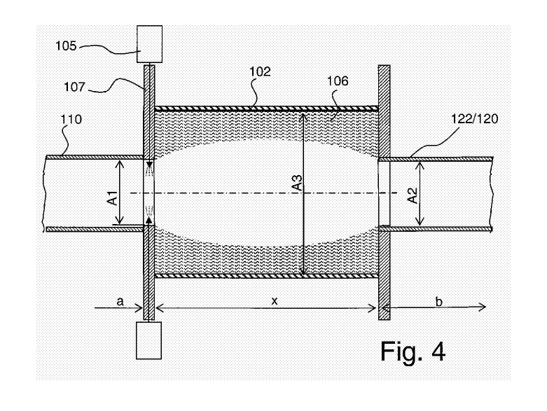

FIG. 4 shows a fourth preferred embodiment of the invention that can be applied on all of the embodiments described above. A variant is shown here in which the first pipe 110 and the second pipe 120 in the extreme case can have the same diameter as the first and second throttle sections, A1 and A2, respectively. It is ensured also in this variant that a volume of fibres 106 is retained in the chamber.

The following advantages are achieved by the invention, in comparison with the prior art, where steam is added to a pipe that transports a flow of cellulose pulp:
Reduced occurrence of steam implosions.
Reduced vibration, blows, reports and bangs caused by steam implosions.
It is avoided that the arrangement for the addition of steam and its associated pipes are shaken to pieces and cause interruptions in operation, and it is not necessary to use heavy and over-dimensioned foundations or pipes that withstand these powerful bangs.
It is possible to raise the degree of heating closer to, or even above, the level at which steam implosions otherwise would start to occur. Furthermore, the superheating of the steam can be increased.

The cross-sectional areas A2 and A1 of flow have a dimensional relationship such that A2 may be the same size as A1, but it is an advantage if it is larger, since the flow in the pipes increases after the positions of addition in the first throttle section 107.

It is sometimes appropriate in association with the addition of steam to add oxygen gas in the same or in neighbouring addition arrangements in the first throttle section. Also other additive chemicals can in the same way be added. These may be added in an indexed manner in the first throttle section 107. If, for example, steam addition takes place at positions that correspond to twelve, three, six and nine o'clock; then the additive chemicals can be added at half past one, half past four, half past seven and half past ten. It is also possible in FIG. 3 that the additive chemicals are added at either one of the two flange plates 107, while steam is added at the other.

The invention is not limited to the embodiments described above, and several variants are possible within the framework of the attached patent claims. It will be obvious for one skilled in the arts that pipes, chambers, etc., also can have other cross-sections than the purely circularly cylindrical cross-sections shown above, such as, for example, rectangular.

1. An arrangement to counteract problems associated with mixing in steam into a pipe that is transferring a flow of pulp of medium consistency, comprising a chamber with a cross-sectional area, and a pre-determined length, that the chamber is in connection, upstream to the flow of pulp, with a first throttle section that has a cross-sectional area, the addition of steam through supply means takes place in this first throttle section, that the first throttle section is in turn in contact, upstream, with a first pipe, that the chamber is in connection, downstream to the flow of pulp, with a second throttle section that has a cross-sectional area, that the second throttle section is in turn in contact with a second pipe, that the cross-sectional area of the chamber is at least 50% greater than the cross-sectional area of the first throttle section and the cross-sectional area of the second throttle section, and that the decrease in area between the cross-sectional area of the chamber and the cross-sectional area of the second throttle section takes place instantaneously, in one single step.

2. The arrangement according to claim 1, wherein the increase in area between the cross-sectional area of the first throttle section and the cross-sectional of the chamber takes place in one single step.

3. The arrangement according to claim 1, wherein the increase in area between the cross-sectional area of the first throttle section and the cross-sectional area of the chamber takes place within a stretch that is less than the diameter, or another equivalent measure of cross-sectional area of the first throttle section.

4. The arrangement according to claim 1, wherein the length of the chamber (x) is at least 1.5-2 times the diameter of the chamber, or another equivalent measure of cross-sectional area of the chamber.

5. The arrangement according to claim 1, wherein the length of the chamber is up to 10 times the diameter of the chamber, or another equivalent measure of cross-sectional area of the chamber.

6. The arrangement according to claim 1, wherein the chamber is limited in the radial direction by a cover.

7. The arrangement according to claim 6, wherein the said cover is constituted by a circularly cylindrical pipe element.

8. The arrangement according to claim 6, wherein the cover is in connection with the first throttle section through flanges and that the cover is in connection with the second throttle section through flanges.

9. The arrangement according to claim 1 wherein the cellulose pulp of medium consistency has a pulp concentration of 8-16%.

10. The arrangement according to claim 1 wherein the cross-sectional area of the first pipe is greater than the cross-sectional area of the first throttle section.

11. The arrangement according to claim 10 wherein the cross-sectional area of the first pipe is more than 50% greater than the cross-sectional area of the first throttle section.

12. The arrangement according to claim 1 wherein the addition of steam through supply means also takes place in the chamber.
